(19) United States
(12) Patent Application Publication
(10) Pub. No.: US 2026/0364938 A1
(43) Pub. Date: Nov. 19, 2026

(54) METHOD FOR SEPARATING LAYERS OF MULTIMATERIAL SUBSTRATES

(71) Applicants: Jay R. Shepherd, Plain City, OH (US); Angela K. Shepherd, Plain City, OH (US)

(72) Inventors: Jay R. Shepherd, Plain City, OH (US); Angela K. Shepherd, Plain City, OH (US)

(21) Appl. No.: 19/211,746

(22) Filed: May 19, 2025

(51) Int. Cl. B32B 43/00; B29B 17/02; B29L 31/00; B32B 41/00

(52) U.S. Cl. CPC B32B 43/006; B29B 17/02; B32B 41/00; B29L 2031/712; B32B 2309/70

(57) ABSTRACT

A method is provided for separating bonded multi-layer materials for recycling by using laser energy to delaminate components of a laminated substrate without melting or distorting the individual layers. One or more laser systems are used to target specific depths within the substrate, from outer to inner layers, while maintaining the structural integrity of each layer. The process selectively ablates bonding agents that join the layers, making it applicable to single-ply and laminated structures. The method is adaptable to various materials, including conductive layers, coatings, and multi-layer laminates, and may be implemented using any laser system capable of delivering energy suitable for delaminating multi-layer substrates for reclamation or recycling.

### CROSS-REFERENCE TO RELATED APPLICATIONS

This patent application relates to and claims the benefit of U.S. Provisional Patent Application No. 67/717,334 filed on Nov. 7, 2024, the disclosure of which is incorporated herein by reference.

### BACKGROUND OF THE INVENTION

Multi-layer packaging substrates are engineered composites that meet specific functional and aesthetic requirements. Commonly used layers include OPP, PET, PE, metals, vacuum-coated aluminum, inks, coatings, and adhesives. Each layer serves a purpose such as providing barrier protection, mechanical strength, or light-blocking properties.

Packaging designs must address the needs of the contents they encase. Single-layer substrates often fall short, necessitating multi-layer constructions that combine distinct material advantages but complicate recycling.

Packaging machinery like vertical form fill seal (VFFS) systems require substrates with specific properties. For example, high-temperature-resistant outer layers withstand sealing jaws, and inner PE layers provide sealability and appropriate coefficients of friction (COF).

Current recycling methods for multi-layer packaging include mechanical, chemical, and compatibilizer-based processes. These methods often result in downcycling, require hazardous solvents, or are cost-prohibitive and inefficient at full separation.

Compatibilizers, such as maleic anhydride, are used to enhance interlayer adhesion. However, they add complexity, cost and are not universally effective across all material types.

EP3957475A1 discusses compatibilizer integration to improve recyclability but highlights limitations such as mechanical degradation and ineffectiveness for metal or ceramic-containing structures.

BRPI1104689A2 describes mechanical recycling via shredding, but bonded layers often remain intact, leading to cross-contamination and lower-value reclaimed materials.

The same patent includes a chemical recycling approach using solvents to dissolve adhesives. While effective in some cases, it is costly, hazardous, and often results in only partial separation.

In response to growing consumer and regulatory pressure, large consumer packaged goods (CPG) companies have committed to transitioning toward recyclable, biodegradable, and compostable packaging formats. One common approach is the adoption of recyclable mono-material structures, such as PE/PE laminations, intended for collection through store drop-off programs. However, this model relies heavily on the end-user as the collecting agent, and its success is limited by consumer participation.

Store drop-off bins are often contaminated with food-soiled packaging, turning these areas into costly liabilities rather than effective recycling channels. Furthermore, the lack of infrastructure and education around acceptable materials diminishes recovery rates.

Alternative programs, such as those offered by TerraCycle™, aim to improve collection by allowing consumers to return hard-to-recycle items directly to the company for processing. While commendable in concept, this model introduces unique logistical and health-related challenges.

For instance, shipping food-contaminated packaging—such as a spicy taco sauce packet—poses risks not only of uncleaned package leakage but also potential allergic exposure. In one such scenario, a U.S. postal worker with a food allergy could unknowingly encounter a soiled pouch during transit, highlighting public health concerns that accompany such returns.

Compostable packaging presents another sustainability-driven innovation, but it currently lacks the technical development necessary to replace high-barrier, multi-material laminations. These structures must protect food from oxygen, moisture, light, and contaminants while withstanding filling and sealing processes.

Most compostable solutions do not meet these performance thresholds and using them in place of traditional films may compromise food safety and product shelf life. Although industry players continue to invest in these technologies, none of the current alternatives have achieved the functional or cost parity required to replace legacy high-barrier flexible packaging structures at scale.

These limitations prevent scalable, cost-effective recycling of multi-layer laminates, resulting in lost opportunities to reclaim high-value materials.

Multi-layer packaging waste exists in many forms—converter master rolls, misprinted or out-of-spec substrates, formed pouches, and crumpled remnants in waste streams. An ideal recycling method must accommodate all these types.

The inventors have partnered with a global packaging converter with multi-billion-dollar market capitalization, along with a Fortune 100 U.S.-based food producer, to validate the scalability and commercial feasibility of the proposed separation method. Both organizations operated under non-disclosure agreements (NDAs) to evaluate the method's performance and its alignment with real-world waste streams. The packaging converter focused on regrinding the separated material layers and incorporating them into new substrate formulations as replacements for virgin resins. Initial testing was overwhelmingly positive, demonstrating that the reclaimed materials retained sufficient quality and performance characteristics for reuse in flexible packaging. The food producer explored the method's potential integration within its packaging supply chain, particularly for complex multi-layer structures. Both parties emphasized the need for a non-provisional patent to proceed with deeper evaluations and to initiate further technical and commercial development.

Therefore, there is a need for a laser-based delamination method that uses off-the-shelf components to separate layers cleanly without damaging substrates, enabling efficient upcycling. The proposed system offers a high degree of repeatability once laser parameters are optimized for a given material structure, making it suitable for consistent deployment in industrial and commercial recycling environments.

### SUMMARY OF THE INVENTION

In this disclosure, the terms “delaminating,” “ablation,” and related variations are used interchangeably to describe the process of separating coatings from single-layer substrates or separating individual layers in multi-layer substrates. Those skilled in the art will recognize the equivalence and relationship of these terms in the context of material processing.

Additionally, the terms “multi-layer packaging,” “multi-layer substrates,” “multi-layered,” and “multi-layer” are used interchangeably throughout this disclosure to refer generally to materials composed of more than one layer. These constructions may include layers of polymers, metals, adhesives, coatings, and other materials, each serving functional or aesthetic purposes.

The present invention pertains to a method for separating individual layers in multi-layer substrates, in roll or non-roll formats, using laser energy. The method uses energy-absorbing layers as catalysts for separation. Laser beams, directed between layers, allow for delamination without melting or degrading individual substrates.

Energy-absorbing zones may include any material that absorbs laser energy. As the roll rotates or the substrate moves, laser beams interact with it to produce separation patterns. Residues or dust may remain or be removed via vacuum or other means.

One or multiple lasers may process patterns either simultaneously or sequentially. Beam depth and focus may be manually or automatically adjusted. A defocused beam often improves delamination results and widens the effective parameter range.

The substrate may consist of similar or dissimilar laminated materials. Laser ablation may act as a standalone process or integrate into converting/recycling lines. The pattern may fully remove energy-absorbing material to allow separation for recycling.

The material may remain stationary while the laser rotates, or vice versa.

Laser beams may target adhesives, coatings, inks, or metals without damaging surrounding layers. Parameters such as, but not limited to, beam size, frequency, and duration are selected for optimal separation.

In one embodiment, a roll of reverse-printed polyethylene terephthalate (PET) laminated to metallized polyethylene (MET PE) is mounted onto a servo-driven mandrel that allows the roll to rotate at a controlled speed. A stationary laser system is positioned adjacent to the rotating roll such that the focal point of the laser beam can be selectively adjusted to ablate surface and interlayer materials at varying depths, from the outermost surface down toward the roll core. This configuration enables continuous layer separation along the circumference of the roll while maintaining precise energy delivery. The rotational motion and focal depth control prevent excessive heat buildup, thereby minimizing thermal distortion or deformation of the individual layers. This method demonstrates the feasibility of reclaiming multi-material packaging substrates directly from roll stock, preserving the integrity of each separated material for like-kind recycling or reuse.

In another embodiment, one or more overhead lasers are used to process flat substrate pieces that maintain a substantially planar configuration. These materials may be placed on a flat surface or secured beneath transparent materials such as glass to ensure minimal curvature or dimensional distortion. Because the substrates exhibit little to no Z-axis variation, the laser system can operate with a consistent focal length, enabling controlled ablation of surface and interlayer materials without requiring vertical adjustment. This embodiment is especially suitable for delaminating flat, non-curled samples such as trimmed sheets, press-flattened waste, or display prototypes.

Another embodiment addresses crumpled or irregularly shaped waste, such as discarded flexible packaging with varying surface elevations. In this configuration, one or more laser systems are positioned above a moving conveyor and dynamically adjust focus along the Z-axis to accommodate uneven material heights. By using a defocused beam—intentionally broadened to create a larger, less concentrated energy profile—the laser can effectively engage multiple depth layers of the substrate simultaneously. This allows for uniform ablation across the full surface contour of non-uniform items, such as a loosely compacted potato chip bag. The ability to process substrates with variable geometry demonstrates the system's adaptability to real-world post-consumer waste streams, where materials are not presented in controlled or flat configurations.

Another embodiment targets energy-absorbing layers that are concealed from visual detection by the operator. This includes scenarios where the intended substrate is obscured beneath an overlying material, such as a metallized potato chip bag covered by decorative wrapping paper. When properly configured, the laser system is capable of selectively interacting with subsurface layers—such as metallization, ink, or adhesive—while effectively ignoring the visually opaque but non-absorbing outer material. In this case, the overlying wrapping paper does not interfere with the laser's ability to locate and ablate the embedded energy-absorbing components. This enables the system to process multi-layer packaging in waste streams where contaminants or additional coverings obscure the target structure.

In another configuration, multiple laser systems may be arranged around the substrate to provide full-surface coverage and enhance separation efficiency. This modular approach allows one or more lasers to operate concurrently on different regions or layers of the material, enabling higher processing throughput and improved control over ablation depth. The ability to scale the number of lasers based on processing speed, waste volume, or layer complexity ensures the system can be tailored for both low-volume and industrial-scale operations.

Algorithms and sensors may adjust X, Y, Z movement and laser parameters to optimize processing conditions.

The proposed laser ablation innovation is expected to assist in improving the efficiency of downstream chemical or mechanical recycling processes by enabling the removal of difficult-to-separate interlayer components, such as metallized films and adhesives. While full integration with chemical recycling systems has not yet been tested, the method's ability to isolate distinct material layers may reduce contamination and improve material feedstock purity for subsequent processing.

Various embodiments of the proposed laser ablation process are capable of selectively removing bonding agents or barrier layers without melting, distorting, or compromising the structural integrity of adjacent substrates. By carefully tuning parameters such as beam focus, power, frequency, and scan pattern, the system can localize energy delivery to target only the energy-absorbing components. This level of control enables separation even in delicate multi-material constructions where traditional mechanical or thermal methods would risk damaging usable layers.

All testing related to this invention was performed using a 30-watt MOPA fiber laser system paired with a 150 mm lens. This configuration was used to develop and validate the delamination process across a variety of flexible packaging structures. The results confirmed the system's ability to separate layers in PET/PE, MET OPP/OPP, paper-based, and other multi-material substrates commonly found in food and industrial packaging. While all testing to date has been conducted using this specific laser setup, the method is expected to be compatible with other laser systems capable of delivering similar pulse durations, beam shaping, and energy control.

Unlike traditional laser applications that rely on a tightly focused beam, the proposed method intentionally uses a defocused beam profile to broaden the laser's area of impact. This approach enables more forgiving ablation across the X, Y, and Z axes, allowing the process to operate effectively without requiring precise alignment or substrate uniformity.

Through iterative testing, operators can identify effective laser parameters tailored to the characteristics of each multi-layer substrate. These parameters may include pulse duration, beam focus, frequency, scan pattern, and power output.

Testing has demonstrated that the process is tolerant of a wide range of parameter combinations. Optimal delamination has been achieved using varying power levels, frequencies, hatch patterns, and focal offsets—proving the system's adaptability across packaging formats without the need for tight calibration tolerances.

The method has proven applicable to an array of flexible packaging types, including those incorporating polymers, metals, paper, adhesives, inks, coatings, and natural or synthetic materials. This broad compatibility allows the innovation to address waste streams composed of diverse substrate constructions.

As used throughout this disclosure, the terms “delaminate” and “ablation” refer to the targeted modification of energy-absorbing materials using laser energy. These materials may be applied, bonded, laminated, or coated within a substrate structure.

While specific examples have been provided, the invention is not limited to the tested packaging types. Other laminated or bonded films, including future material structures not yet commercialized, fall within the scope of the described method.

The innovation distinguishes itself by enabling layer separation in a way that preserves material integrity, thereby supporting like-kind reuse or upcycling. Industry stakeholders—including major food producers and packaging converters—have expressed strong interest in commercializing the method, citing its potential to fill a critical gap in recycling workflows for multi-layer flexible packaging.

### BRIEF DESCRIPTION OF DRAWINGS

The illustrations depict various multi-layer packaging types processed with the proposed technology, including unused, sealed, and contaminated packages. These visuals demonstrate the technology's efficacy across packaging types commonly found in landfills and MRFs, addressing contamination challenges posed by adhered waste, residues, and sealed content.

FIG. 1 illustrates an off-the-shelf computerized laser system that mimics the equipment used to validate the proposed invention.

FIG. 2 shows a cross-sectional view of a multi-layer substrate typically used in food packaging and found in landfill waste.

FIG. 3 demonstrates a lasering system aligned with a horizontal form fill seal (HFFS) package, processed using the material separation method.

FIG. 4 displays a lasering system configured for processing a roll format substrate using the material separation method.

FIG. 5 presents a test pattern for determining optimal laser settings.

FIG. 6 depicts an unopened peanut butter sachet treated with the material separation method, showing delamination of the top layer from the bottom substrate layer.

FIG. 7 displays a potato chip pillow pack before and after processing with the proposed method.

FIG. 8 shows an unopened dry soup mix package in a paper-based multi-layer substrate, treated to achieve delamination of the top layer from the bottom substrate layer.

FIG. 9 presents a taco sauce packet processed with the proposed method, comprising layers of PET, ink, adhesive, foil, and PE, illustrating a challenging recycling format commonly found in landfills.

FIG. 10 shows an unopened peanut butter stand-up pouch with a dispensing spout, processed to separate substrate layers using the proposed method.

FIG. 11 illustrates a conceptual machine design for the proposed separation process, intended for processing industrial master roll waste.

FIG. 12 is a flowchart outlining the overall process of the proposed invention, including the separation, shredding, extrusion, and reuse of multi-layer packaging materials.

FIG. 13 depicts a 3D printing benchmark model containing geometric features such as overhangs, bridges, holes, and fine details used to evaluate material performance.

### DETAILED DESCRIPTION OF DRAWINGS

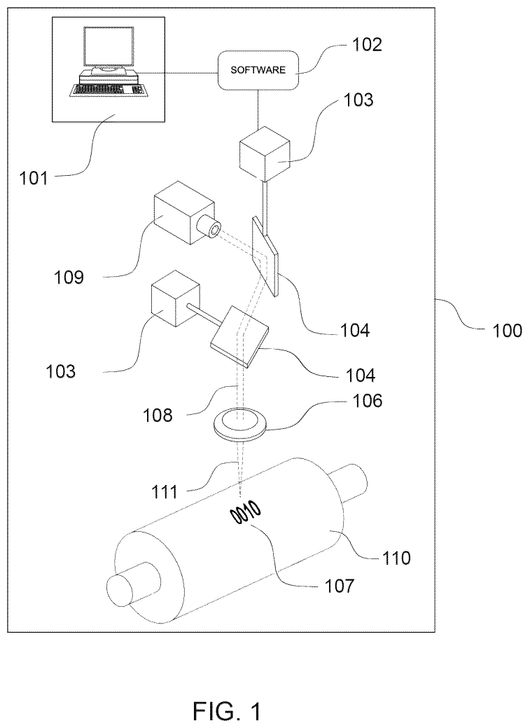

FIG. 1 illustrates a galvanometer laser system 100, including a computer system 101 running galvo laser software 102. The system transmits instructions to a laser beam expander 109 and galvo motors 103 and mirrors 104, directing a laser beam 108 onto a metallized roll substrate 110. A lens 106 focuses the beam, creating a trajectory pattern 111 for image transfer onto the substrate.

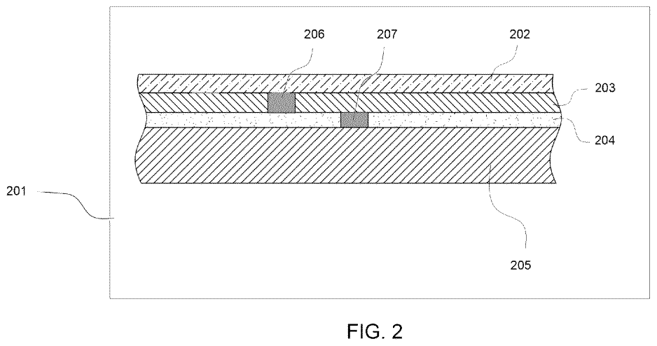

FIG. 2 shows a cross-sectional view of a typical multi-layer substrate 201 used in food packaging, comprising layers of polyester (PET) 202, adhesive 203, vacuum metallized aluminum 204, and polyethylene (PE) 205. Ablation zones 206 and 207 target the separation between the PET 202 and aluminum 204, and between aluminum 204 and PE 205. Layers are not to scale.

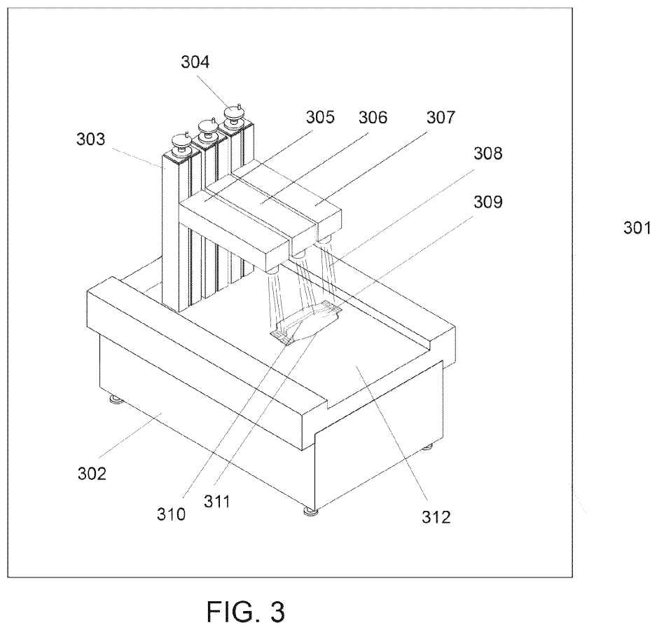

FIG. 3 illustrates a stand-alone lasering system 301 for processing flexible, non-roll packaging. The system includes a base support 302 holding a galvanometer lasering setup with multiple focusing lenses 305, 306, 307 on Z-axis towers 303. Servo controls 304 adjust lens positions to enable precise ablation at target locations 310 and 311 on substrate 309.

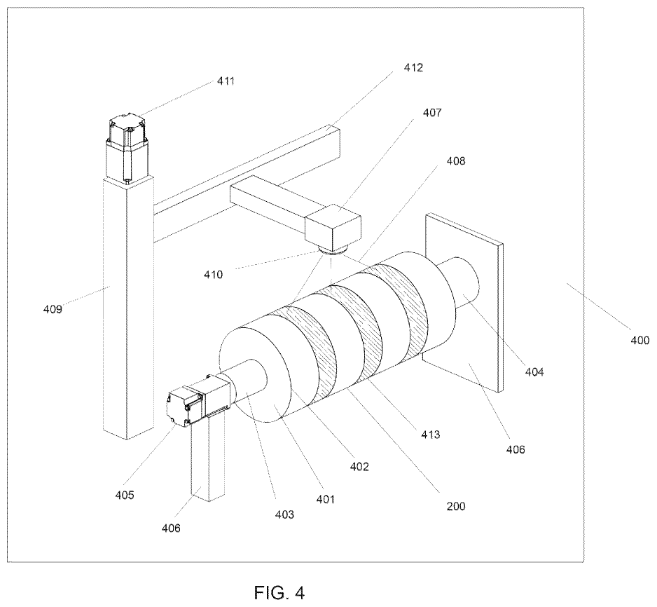

FIG. 4 presents an overview 400 of a stand-alone lasering system for processing multi-layer substrates in roll form. The substrate roll 401, wound on core 403 and mounted on rotating shaft 404, is driven by a unit 405 and supported by structures 406. The lasering unit 407 is positioned to ablate the substrate as it rotates.

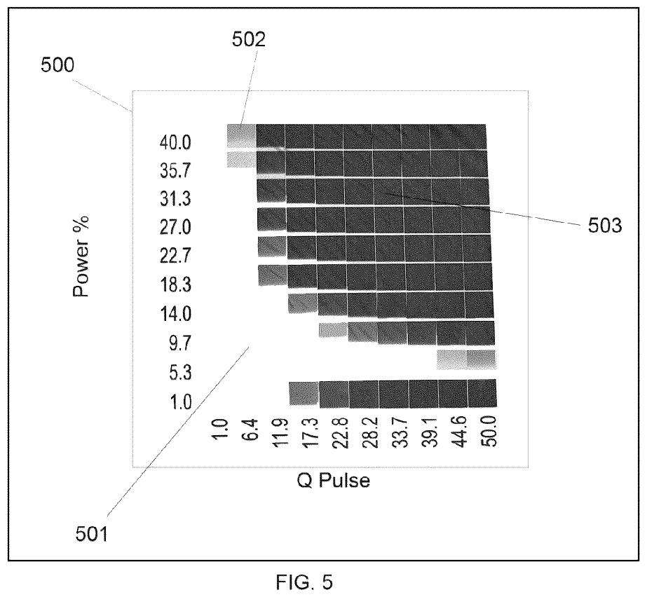

FIG. 5 shows a test pattern matrix on a film swatch 500 of OPP MET/OPP subjected to laser ablation. The matrix includes 100 square patterns, representing various laser settings. Area 501 remains unablated, 502 shows partial delamination, and 503 displays full delamination. Optimal settings for delamination were determined and saved for reproducibility.

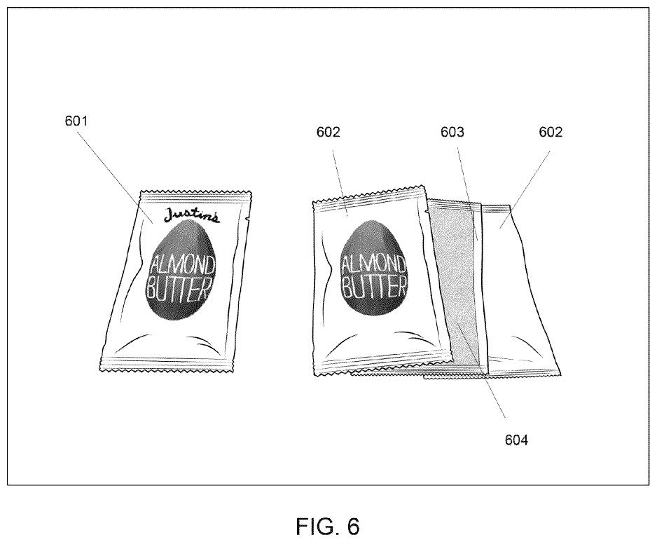

FIG. 6 illustrates a sealed peanut butter sachet made of PET, ink, adhesive, vacuum metallized aluminum, and LLDPE. Control package 601 and separated layers 602, 603, and 604 (contents) demonstrate effective delamination achieved with the proposed method under specified laser parameters.

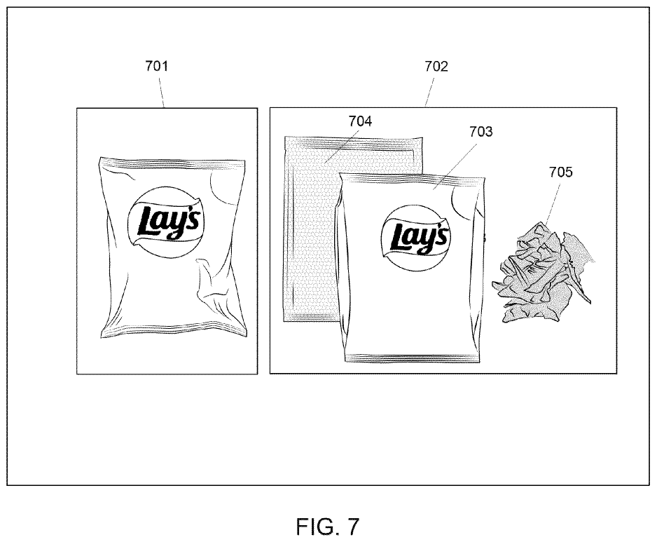

FIG. 7 shows a potato chip package before and after processing, with a substrate consisting of OPP, print layer, adhesive, MET OPP, and PE. Processed areas include delaminated OPP film 703, ablated MET OPP layer 704, and PE sealant 705.

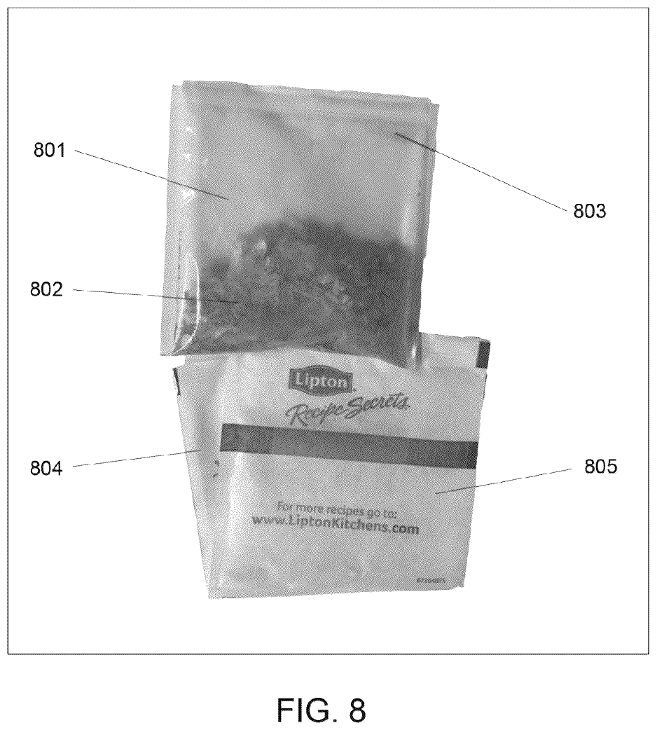

FIG. 8 depicts an unopened dry soup mix package with Print/Paper/Adhesive/MET/PE layers. The image shows successful separation of the outer paper layers 804, 805 from the PE layer 801, with visible remnants of metallized aluminum layer 803.

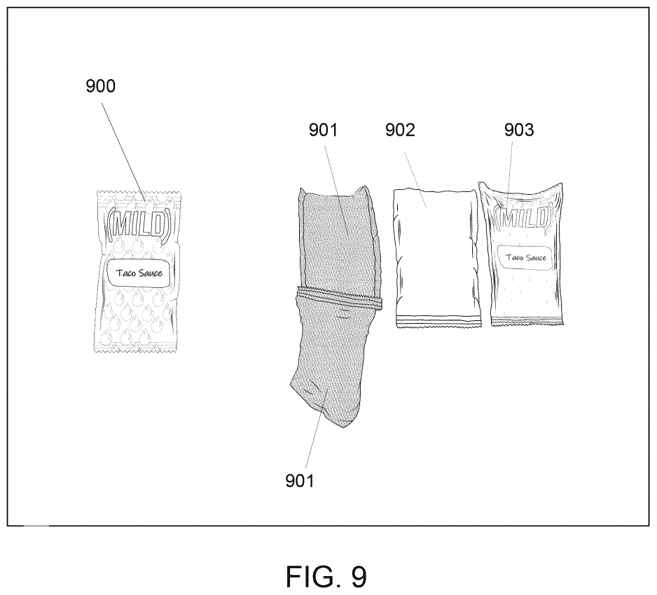

FIG. 9 presents a taco sauce packet, before (900) and after (901, 902, 903) processing. The package consists of PET, ink, adhesive, foil, and PE. Foil charring (901) and separated PET 903 and PE 902 layers demonstrate the process's ability to address challenging multi-layer recycling formats.

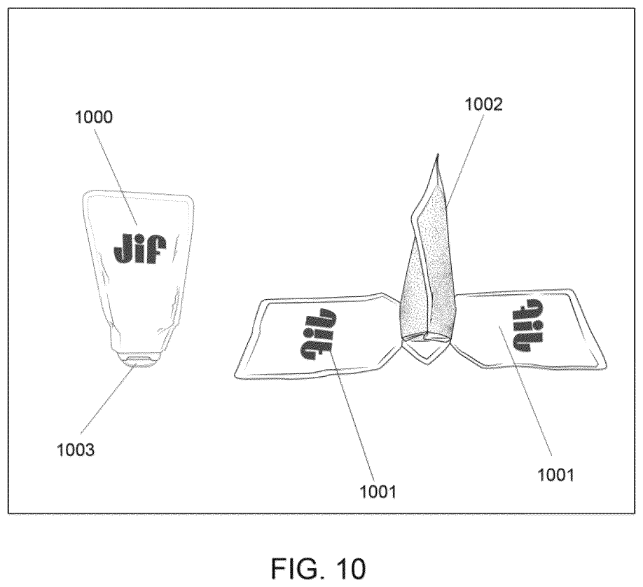

FIG. 10 shows an unopened peanut butter pouch with dispensing spout 1003. Control 1002 and separated outer PET layer 1001 and inner layers 1202 demonstrate delamination, using the ink layer as a catalyst for effective separation.

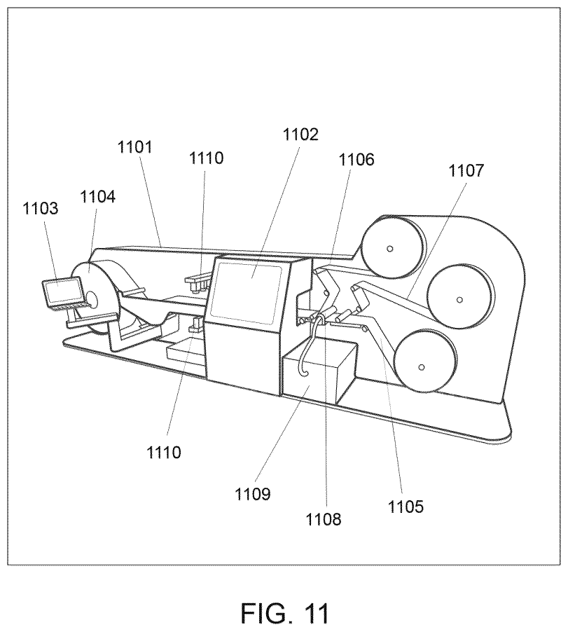

FIG. 11 illustrates a conceptual machine design 1101 for processing industrial master roll waste. The lasering system 1102, controlled by monitor 1103, ablates a tri-laminated master roll 1104 into independent rolls 1105, 1106, 1107. Vacuum cleaning system 1108 removes residual metals, inks, and adhesives into containment area 1109.

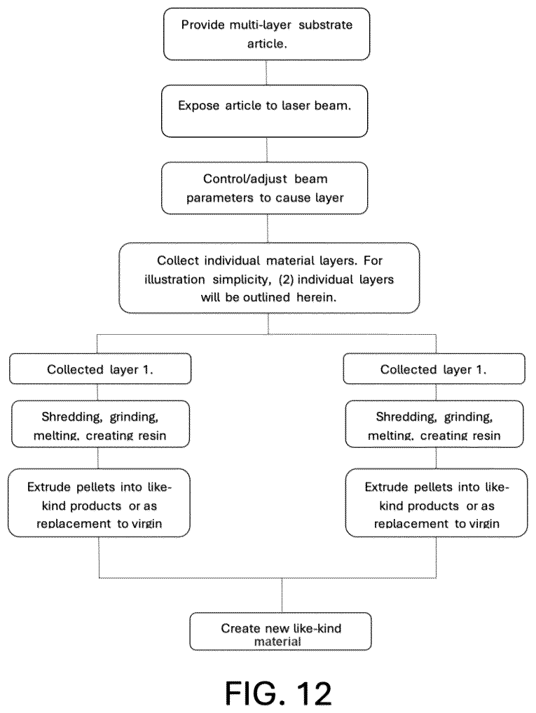

FIG. 12 illustrates a method for separating, processing, and upcycling individual material layers from a multi-layer substrate article.

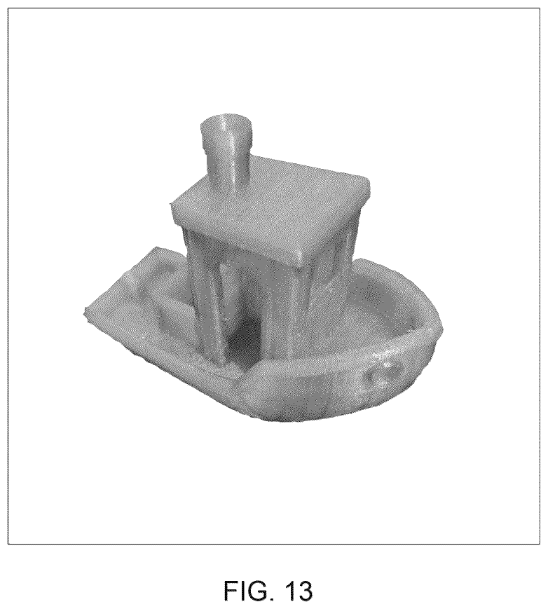

FIG. 13 depicts a three-dimensional (3D) printed object fabricated using reclaimed polyethylene terephthalate (PET) material. The PET was separated from a PET/PE multi-layer substrate using the laser-based delamination process described herein. Following separation, the PET layer was ground, melted, and extruded into 3D printer filament. The filament was then used to produce the pictured object, demonstrating successful upcycling of the recovered material into a functional, like-kind application.

The illustrations depict various multi-layer packaging types processed with the proposed technology, including unused, sealed, and contaminated packages. These visuals demonstrate the technology's efficacy across packaging types commonly found in landfills and MRFs, addressing contamination challenges posed by adhered waste, residues, and sealed content.

### Detailed Description of the Invention

At The process begins with a multi-layer substrate article being provided. This article comprises at least two material layers that are bonded or laminated together.

The article is then exposed to a laser beam. The laser beam may be emitted from one or more laser sources capable of selectively interacting with energy-absorbing components of the substrate.

Next, beam parameters are controlled or adjusted to initiate layer separation. This may include adjustments to wavelength, power, pulse width, repetition rate, and focal depth, depending on the material properties of the substrate.

Following separation, the individual material layers are collected. For illustration simplicity, the flowchart outlines a scenario involving two layers, although the method is not limited to two.

Each collected layer (denoted as “Collected layer 1” and “Collected layer 2”) is subjected to further processing steps. These may include shredding, grinding, and melting to create a flowable resin or molten polymer suitable for further conversion.

The resulting resin is then extruded into pellets, which may be used to manufacture like-kind products or serve as a replacement for virgin material in similar applications. For example, a PET layer may be re-extruded into new PET film, bottles, or trays, while a PE layer may be converted into new PE film or bags.

Finally, the process culminates in the creation of new like-kind material, effectively upcycling the original multilayer article into reusable input materials, thereby reducing waste and avoiding downcycling.

In this disclosure, the terms “delaminating,” “ablation,” and related variations are used interchangeably to describe the process of separating coatings from single-layer substrates or separating individual layers in multi-layer substrates. Those skilled in the art will recognize the equivalence and relationship of these terms in the context of material processing.

Additionally, the terms “multi-layer packaging,” “multi-layer substrates,” “multi-layered,” and “multi-layer” are used interchangeably throughout this disclosure to refer generally to materials composed of more than one layer. These multi-layer constructions may include, but are not limited to, layers of polymers, metals, adhesives, coatings, and other materials, each serving specific functional or aesthetic purposes. This interchangeable nomenclature is intended to encompass any material system with two or more distinct layers, regardless of the specific configuration or application.

The present invention pertains to a method for separating individual layers in multi-layer substrates, provided in roll or non-roll formats, using laser energy. The method involves using energy-absorbing layers as catalysts for separation, such as polymers, natural materials, metals, inks, adhesives, or coatings. One or more laser energy sources are positioned in proximity to these energy-absorbing layers. The laser beams, directed between layers, allow for partial or complete delamination without melting or degrading individual substrates. The laser focus can be adjusted to target specific depths, effectively processing substrates even when in roll form, wrinkled, or crumpled.

The energy-absorbing zones may include any material that absorbs laser energy. The rotation of the roll or movement of the substrate exposes the surface to laser beams, creating processing patterns. Residues of the energy-absorbing material, or dust, may remain or be removed by vacuum or other means, as needed.

Multiple lasers can process patterns on single-layer or multi-layer substrates either simultaneously or sequentially. The depth of the laser beams may be manually or automatically adjusted to ensure precise processing depth. The laser's focal point can be set precisely or defocused, depending on the lens used. A defocused beam provides better delamination results than focused techniques and offers a broader processing window for parameters such as power, frequency, and hatch pattern.

The substrate may be a lamination of similar-material construction, or a lamination of dissimilar materials. Laser ablation can function as a standalone process or integrate into existing converting or processing lines such as, but not limited to, chemical recycling. The ablation pattern can be configured for complete removal of energy-absorbing material, allowing each distinct material to be collected separately for recycling back into same material products or further waste material processing.

The material can remain stationary while the laser rotates around it, or the material may move while the laser remains stationary.

The method uses the laser system's output beam to target specific bonding agents—such as adhesives, coatings, inks, or metals—without significantly affecting other layers. Laser parameters like beam size, intensity, pulse energy, frequency, and duration are carefully selected to achieve complete or partial delamination of the substrate.

In one embodiment, a roll format material is positioned on a servo-driven support mandrel, rotating as a stationary laser system ablates the bonded layers. Example of a roll format item that can use the innovation is an unusable roll of printed vertical form fill and seal (VFFS) created at a packaging converter facility comprising of a reverse printed polyester (PET) laminated to a metallized polyethylene (MET PE) that's missing proper allergen nomenclature; such a product is destined for the landfill and too costly for sending to chemical recycling facilities. Without utilizing a cost-effective recycling process that utilizes off-the-shelf equipment, such material is either discarded or down-cycled into lesser-value items, not up-cycled into like-kind items such as new VFFS film.

In another embodiment, flat materials are processed with one or multiple beams stationed above or near the substrate. The laser system's motion and controlled energy allow for versatile delamination patterns.

Another embodiment addresses irregularly shaped or crumpled waste, such as discarded or shredded packaging. The laser system can adapt its focus along the Z-axis to accommodate the material's form.

Another embodiment addresses materials where the energy-absorbing layer, such as metal, is concealed within the substrate and not visible to the operator.

In another embodiment, multiple stationary lasers are positioned around the substrate to target specific segments and provide comprehensive coverage.

The invention may include programming or algorithms that adjust processing conditions such as X, Y, and Z movements. Sensors or pre-set intervals guide these adjustments, optimizing layer separation.

The invention may also enhance chemical or mechanical recycling processes by facilitating pre-separation of materials before further treatment, reducing costs and improving quality in recycled products. In testing, shredded PET/Adhesive/MET/PE substrate was placed onto a conveyor system, where an overhead laser vaporized the metallized layer, separating the PET from the PE and converting the vacuum-coated aluminum into dust. A control sample of the same shredded material was not processed with the laser. Comparative analysis of these samples suggests that this innovation, when applied as a pre-treatment step in pyrolysis or chemical recycling, could provide unique advantages in material recovery efficiency and processing costs.

Various embodiments illustrate the invention's adaptability for delaminating specific layers without damaging adjacent substrates, providing effective laser parameters for multi-layer material separation.

The invention supports scalability, allowing multiple lasers to increase processing speed and handle higher volumes. This scalability is critical for industrial applications, and the ability to ablate in the Z-axis enhances delamination of irregularly shaped materials.

Unlike traditional laser applications that use a tightly focused beam, this invention utilizes a defocused beam to achieve a broader ablation effect across X, Y, and Z axes. This approach enables delamination without precise alignment and accommodates irregularly shaped or crumpled substrates.

Laser operators are expected to understand laser software and drivers and use test patterns and iterative methods to identify effective parameters for various substrates.

Extensive testing was conducted across a range of laser parameters to determine effective settings for delamination. Through this process, the inventors identified an optimal range of settings—including power, frequency, pulse duration, and focal point—that achieves effective delamination without melting, combusting, or damaging individual materials. Notably, these settings did not require tight tolerances; instead, a broad range of values proved effective, promoting ease of use and adaptability once the ideal operating range was established. The inventors used a 30-watt MOPA Fiber laser system and a 150 mm focused and defocused lens, but the method applies to various laser types and configurations.

The embodiments described here illustrate the invention's adaptability to different applications and materials, as recognized by those skilled in the art.

In this disclosure, terms such as “delaminate” and “ablation” refer broadly to modifying energy-absorbing components of a substrate with laser energy. This includes materials such as paper, polymers, wood, metals, inks, coatings, and adhesives, whether coated, laminated, or printed on a substrate.

While specific examples are given, the invention is not limited to outlined materials or configurations. Other films and laminates fall within the scope of the invention. The invention's focus is the method of separating multi-layer materials for recycling and upcycling applications.

The invention uniquely addresses the delamination of multi-layer materials, particularly for recycling purposes, distinguishing itself from prior innovations by focusing on material separation for reuse using lasering systems as the catalyst for ablating. Under NDA, packaging industry leaders have expressed significant interest in advancing this innovation. For example, a major food company, upon the issuance of a non-provisional patent, has committed to introducing the inventor to a large U.S. recycling organization to further develop the implementation of this technology into existing recycling streams. Additionally, several venture capital firms, identified by these industry partners, have indicated readiness to promote further development upon patent approval. This industry support underscores the invention's transformative potential for scalable recycling solutions and its anticipated impact in helping develop end-of-life solutions for barrier packaging substrates.

### Examples and Embodiments

Each example presented here required an iterative trial-and-error approach to determine the optimal laser settings for effective separation. The laser parameters—such as power, pulse duration, frequency, hatch pattern, and beam focus—were adjusted based on the specific material composition and structure of each packaging type. While detailed laser settings for every test are not provided, these examples illustrate the flexibility and adaptability of the process across a range of packaging formats, demonstrating its suitability for diverse recycling applications.

Example 1: Metallized Polyester and Polyethylene (PE) in Bakery Overwraps and Candy Packaging. This example involves a substrate composed of metallized polyester (MET PET) bonded to polyethylene (PE) with an adhesive layer, commonly used in horizontal form-fill-seal (HFFS) applications for bakery overwraps, candy wrappers, and other packaging that benefits from a metallized appearance. Using a galvanometer-configured laser system with a 110 mm lens, 33 ns Q pulse, and 76 kHz frequency, complete delamination of the MET layer was achieved, leaving the PE layer intact for easy separation. This test demonstrates the process's suitability for high-barrier, multi-layer packaging with contamination resistance, allowing for the recovery of individual materials for recycling.

Example 2: Paper and Metallized Polyethylene (MET PE) in Soup Mixes and Spices. This test targeted a multi-layer packaging material composed of paper and metallized polyethylene, often used for soup mixes, spices, powdered drink stick packs, and sandwich overwraps. Laser settings included 89% power, 200ns Q pulse, and 4,000mm/s scan speed. The MET layer vaporized cleanly, enabling separation from the paper layer. This example highlights the technology's adaptability for multi-layer substrates with fiber and polymer components commonly found in shelf-stable food products.

Example 3: Oriented Polypropylene (OPP) and Metallized Oriented Polypropylene (MET OPP) in Snack Food Packaging. This example involved snack packaging made from OPP and MET OPP layers, as seen in potato chip bags, candy bar wraps, and frozen food packaging. Laser parameters were set to a 110 mm lens, 55% power, and 76 kHz frequency, achieving complete separation of the MET OPP layer from the OPP without melting or damaging the substrate. This test demonstrates the process's effectiveness for common snack food packaging with strong inter-layer bonds and enhanced barrier properties.

Example 4: Complex Barrier Layers in Bacon Bit Pouches and Produce Packaging. This test addressed packaging with complex barrier layers, such as those used for bacon bits, cookie pouches, grains, lidding films, and fresh produce. These products require barrier properties that retain freshness while preventing contamination. The laser effectively separated multi-layer components, enabling recovery of individual layers for recycling. This example underscores the versatility of the technology in addressing high-barrier food packaging materials found in diverse applications.

Example 5: Cold Seal Packaging for Energy Bars and Gummy Candies. The final test focused on cold-seal packaging, commonly used for products like energy bars, holiday candies, and gummy bears, which require specialized sealants and substrates. Laser settings allowed for separation of adhesive layers without disrupting the integrity of the product. This example highlights the adaptability of the process for cold-seal applications and delicate product packaging, providing a sustainable recycling solution for high-value packaged goods.

Example 6: Validating separated materials can be recycled into like-kind products. To validate the effectiveness of the recycling process, separated PET and PE layers were shredded independently and extruded into 3D printer filament using a laboratory bench extruder. Each material was then used to successfully print individual 5″×5″ squares with a thickness of 40 mils. The PET and PE were not combined during this process, demonstrating that each material can be effectively recycled and repurposed into like-kind products, maintaining their individual integrity and higher-value reuse potential.

1. A method for separating and reclaiming bonded layers in a multi-layer substrate, the method comprising:
(a) providing a multi-layer substrate comprising at least two distinct material layers bonded or laminated together;
(b) directing energy from one or more energy sources toward the substrate, the energy being configured to interact with interfacial or energy-absorbing materials between the layers to weaken or remove the bond;
(c) separating the bonded layers without melting or significantly degrading their structural integrity, such that each layer remains suitable for reuse or recycling; and
(d) arranging the substrate and energy source in a configuration selected from:
(i) a stationary energy source and a moving substrate;
(ii) a stationary substrate and a moving energy source; or
(iii) a combination of both fixed and movable energy sources.

2. The method of claim 1, wherein the energy source is selected from fiber lasers, diode lasers, MOPA lasers, UV lasers, near-infrared lasers, or any future-developed energy-emitting system capable of selective layer ablation or interlayer disruption.

3. The method of claim 1, wherein the energy interacts with materials including adhesives, metallization layers, coatings, printed inks, or vapor-deposited barriers.

4. The method of claim 1, further comprising adjusting one or more parameters of the energy source, including beam focus, pulse frequency, hatch pattern, wavelength, power level, or exposure time, based on the composition of the substrate layers.

5. The method of claim 1, wherein the substrate comprises layers selected from polymers, paper, biodegradable materials, compostable materials, natural fibers, metals, or combinations thereof.

6. The method of claim 1, wherein the separated layers are subsequently reclaimed and processed into like-kind products including films, packaging, or extruded materials.

7. The method of claim 1, wherein the separation is performed without prior surface cleaning, and the process is tolerant of surface residue, physical imperfections, or deformation in the substrate.

8. The method of claim 1, wherein the separation process is performed as a pre-treatment to enhance the performance or efficiency of a downstream chemical, mechanical, or thermal recycling system.

9. The method of claim 1, wherein an artificial intelligence system or feedback-controlled module is used to monitor substrate type or condition and dynamically adjust energy source parameters in real time.

10. The method of claim 1, wherein multiple energy sources are arranged to simultaneously process different sections, layers, or depths of the substrate to increase delamination efficiency.

11. A system for separating bonded layers in a multi-layer substrate, the system comprising:
(a) one or more energy sources configured to deliver targeted energy to a multi-layer substrate;
(b) a substrate positioning mechanism configured to move the substrate relative to the energy source or vice versa, the mechanism comprising at least one of a conveyor, rotating mandrel, guided track, or robotic arm; and
(c) a control unit configured to adjust energy parameters based on substrate composition or geometry to facilitate separation of the bonded layers without substantial material degradation.

12. The system of claim 11, wherein the control unit includes a sensor-driven feedback loop, or an artificial intelligence algorithm trained to optimize ablation or separation parameters across varying substrate types and conditions.
